(19) United States
(12) Patent Application Publication
(10) Pub. No.: US 2021/0131520 A1
(43) Pub. Date: May 6, 2021

(54) INTEGRATED ELECTRONIC VALVING CONTROL FOR SHOCK ABSORBER

(71) Applicant: SUSPENSION DIRECT INC., LAKE ELSINORE, CA (US)

(72) Inventor: DANIEL J. WORLEY, LAKE ELSINORE, CA (US)

(21) Appl. No.: 17/081,550

(22) Filed: Oct. 27, 2020

Related U.S. Application Data
(60) Provisional application No. 62/929,637, filed on Nov. 1, 2019.

(51) Int. Cl. F16F 9/50; F16F 9/19; F16F 9/32; F16F 9/34; F16F 9/54

(52) U.S. Cl. CPC F16F 9/50; F16F 9/19; F16F 9/58; F16F 9/34; F16F 9/54; F16F 9/3207

(57) ABSTRACT

This invention pertains to hydraulic cylinders or shock absorbers, and a method of controlling the operation and flow of fluid within them. Specifically, this invention relates to use of a coil and valve mounted onto a shock shaft and mounting eyelet absorber or vehicle body) within a shaft and mounting eyelet of a damping assembly that utilizes electronically controlled inputs to regulate operational forces, essentially turning the shaft assembly into a solenoid.

This application claims the benefit of U.S. Provisional Patent Application Ser. No. 62/929,637, filed Nov. 1, 2019. The entire contents of Application Ser. No. 62/929,637 are hereby incorporated by reference herein.

### FIELD OF THE INVENTION

This invention pertains to hydraulic cylinders or shock absorbers, and a method of controlling the operation and flow of oil within them. Specifically, this invention relates to use of a coil and valve mounted onto a shock shaft and eyelet (hereinafter also referring to an mounting eyelet or clevis of a shock/sway bar link/other hydraulic suspension cylinders, which connects the shock absorber and its shaft to a chassis or vehicle body) within a shaft and mounting eyelet of a damping assembly that utilizes electronically controlled inputs to regulate operational forces, essentially turning the shaft assembly into a solenoid valve.

### BACKGROUND OF THE INVENTION

Shocks and other hydraulic suspension cylinders for vehicles typically function by forcibly moving an incompressible liquid back and forth on a fluid path in response to its interaction with a compressible gas. In detail, while the gas is being compressed by the moving force of the liquid, the gas reacts as a spring in response to this movement. On the other hand, as the compressed gas is allowed to expand in reaction to the moving liquid, it forces the liquid to return to a force neutral position on the fluid path. It is also known that some devices for a similar purpose are configured much like a conventional dash pot.

Heretofore, the general approach for adjusting the response characteristics of these hydraulic suspension cylinders has been to modify the fluid path by moving an in-line valve member directly along the fluid path. More specifically, this has been accomplished by increasing or decreasing the in-line cross-section area of the fluid path.

Past electronically controlled shocks and hydraulic suspension cylinders, such as in bypass tube (external) or twin wall shocks (internal), utilize the positioning of a valve member in a direction that is substantially perpendicular to the shock absorbers fluid path, within the top mounting, or bridge near the gas reservoir, of the cylinder to change the response characteristics of the cylinder.

In more common shock absorbers, rebound damping adjustment works in a way that a circuit is created, where oil flows through a shim, piston, and passage within the shock shaft. When an adjustment screw is turned, a needle controlling oil flow can be restricted or allowed to move more freely through the shim and piston, thus controlling the damping. When the system is closed, oil can still bleed by the system, going around the shims if completely closed.

Instead of using the bridge of the shock or an external tube outside of main shock body such as in US Patents US20170291466A1 or U.S. Pat. No. 9,027,937B2, where the solenoid and valving controlling damping is mounted externally, and US20140238797A1 where the electronic controls, including the board, are located within an additional cap on the shock body and ultimately controls the rod as it passes through. With designs using a solenoid mounted to an external tube or bridge, limitations in control exists. These designs can only control the shaft and flow of oil from its movements in an inefficient matter. By utilizing a twin tube shock, these designs can get better control, but the cost would significantly rise. To achieve optimum flow of fluid electronic control in shock absorbers, or hydraulic cylinders, it would be advantageous to develop innovative devices allowing efficient and compact valve control.

### SUMMARY OF THE INVENTION

The object of the present invention is to provide a way of adjusting the response characteristics of the hydraulic suspension cylinders by changing the structure of the typical shock and regulating the modified structure by use of electronic inputs. By utilizing a coil located on one end of the shaft, within the eyelet of the shock or the shaft itself, and a valve on the opposite end of the shaft, near the piston, the shaft would modify the fluid path of the shock, allowing for closed or opened flow operation, determined by the electronic input being received.

### BRIEF DESCRIPTION OF THE DRAWINGS

A clear understanding of the shock with the shock shaft with solenoid summarized above may be had by examining the figures below. The figures display and reference the assembly, which are not necessarily drawn to scale. Accordingly:

FIG. 1: Illustrates a shock with the shock shaft with solenoid system built into it, utilizing a spool type valve, in closed position.

FIG. 2: Illustrates a shock with the shock shaft with solenoid system built into it, utilizing a poppet type valve, in opened position.

FIG. 3: Illustrates a twin tube shock with the shock shaft with solenoid system built into it, utilizing a poppet type valve, in closed position.

FIG. 4: Illustrates a shock with the shock shaft with solenoid system built into it, utilizing a spool type valve, in closed position, with an offset mounting eyelet and housing for the coil.

FIG. 5: Illustrates a shock with the shock shaft with solenoid system built into it, utilizing a poppet type valve, in closed position, with an offset mounting eyelet and housing for the coil.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Furthermore, the term “hydraulic suspension cylinders” refers to any damper cylinder, such as a shock or devices similar to a shock, while “eyelet” refers to the mounting of the shock or hydraulic suspension cylinder's shaft to a chassis mounting point.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A shock shaft with a solenoid built into it and its use within a shock is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

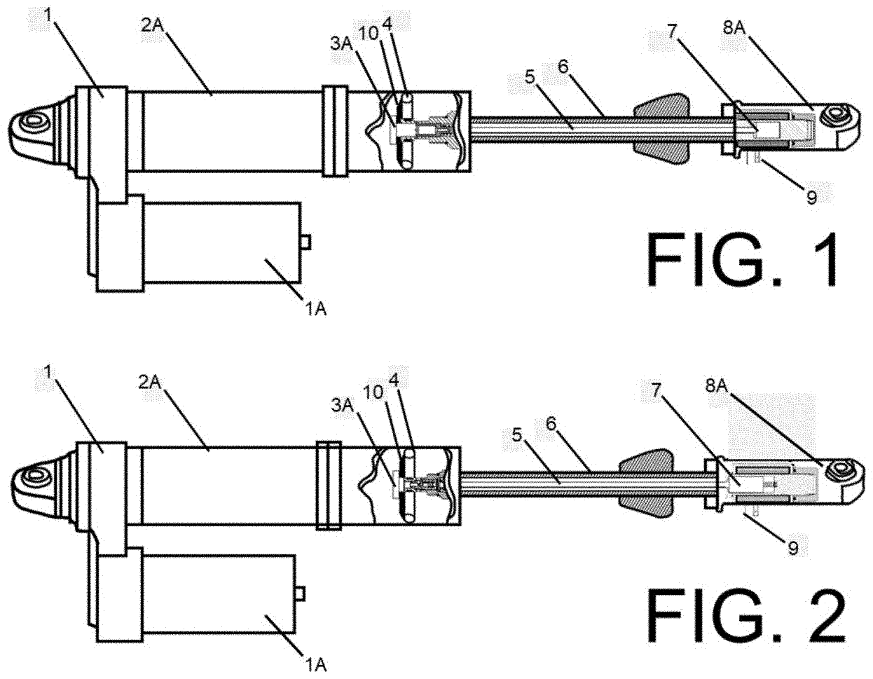

The present invention will now be described by referencing the appended figures representing preferred embodiments. FIG. 1 depicts a shock absorber and its components, where (1) is the bridge connecting the main body (2A) to the reservoir (1A). Shock shaft (6) features a spool valve (3A) that controls flow with a piston (4) mounted to it. The spool valve (3A) is controlled by a coil (7), that is connected by connecting rod (5) and is internally mounted to mounting eyelet (8A). The coil (7) is connected and controlled by an external electronic control unit through terminals (9) outside of the mounting eyelet (8A). The spool valve (3A) controls shims (10).

When in operation, the coil within the mounting eyelet receives electronic input through the terminals, it then pushes the control rod into the spool valve. The spool valve then opens, effecting the shims and controlling flow of fluid through the piston. This modifies the fluid path, increasing or decreasing the response characteristics. How much the valve opens are controlled by the input received by the coil.

In addition to a spool valve, a poppet type valve, which can be piloted or nonpiloted, can also be utilized as seen in FIG. 2, similar to FIG. 1 shows a shock absorber and its components, where (1) is the bridge connecting the main body (2A) to the reservoir (1A). Shock shaft (6) features a piloted poppet valve (3B) that controls flow with a piston (4) mounted to it. The poppet valve (3B) is controlled by a coil (7), that is connected by connecting rod (5) and is internally mounted to mounting eyelet (8A). The coil (7) is connected and controlled by an external electronic control unit through terminals (9) outside of the mounting eyelet (8A). The piloted poppet valve (3B) controls shims (10). This system works similarly to the spool type.

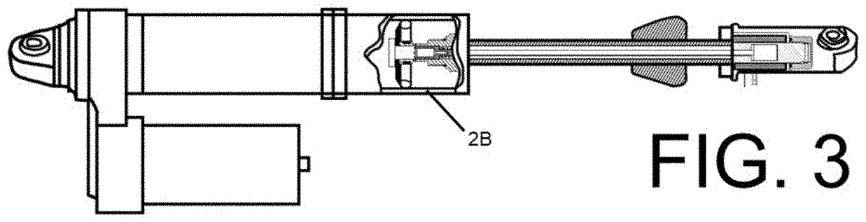

The shock shaft with solenoid built into it is designed to work with many styles of hydraulic cylinders, such as the shocks depicted in FIG. 1 and FIG. 2, as well as twin tube body (2B) shocks depicted in FIG. 3. This design offers an efficient and compact way of electronically controlling the flow of fluid. As it is all contained within the shaft, rather than a different part of the shock. It provides nearly stepless fluid control with efficient performance.

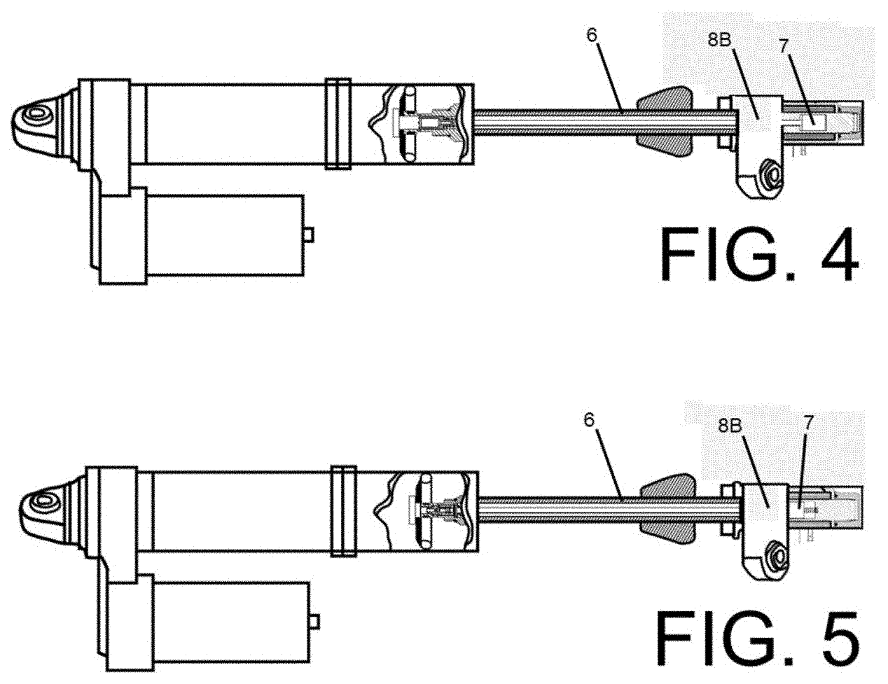

The location of the coil in the shaft also allows for alternate mounting eyelet placements, as seen in FIG. 4 and FIG. 5. To allow for mounting on certain applications, the mounting eyelet (8B) is offset from the shock shaft (6), with the coil (7) still in line with the shock shaft (6) and operating the solenoid system.

1. A shock absorber, or hydraulic cylinder, comprising:
A shock absorber body composed of a cylinder and a cylinder mounting eyelet
A shock shaft assembly, going into and out of the shock absorber body, composed of:
A main shaft composed of the shaft, rubber bumper, lock nuts, and push rod;
A mounting eyelet composed of electronic mounting, coil, bearing, and retainers;
A piston composed of a machined valve with O-rings and band, shims, and mounting valve;
A valve piston holder and mounting to the push rod;
A solenoid assembly comprising:
Terminals connecting said solenoid assembly with external electronic control unit;
A coil located within said mounting eyelet, controlled by said external electronic control unit;
A connecting rod running within said main shaft, controlled by said coil, and controlling said valve;
Wherein the fluid path of said shock absorber, or hydraulic cylinder, are electronically controlled by said solenoid assembly built into said shock shaft assembly.

2. The shock absorber, or hydraulic cylinder, according to claim 1 comprising:
A reservoir composed of the reservoir body, floating piston or bladder, and cap;
A bridge, connecting the shock absorber body to the reservoir.

3. The shock absorber, or hydraulic cylinder, according to claim 1 or claim 2 wherein:
The said shock absorber body is a twin-wall cylinder.

4. The shock absorber, or hydraulic cylinder, according to one of the claims 1 to 3 wherein:
The said mounting eyelet is offset from the main shaft axis.

5. The shock absorber, or hydraulic cylinder, according to one of the claims 1 to 4 wherein:
The said valve is a poppet type valve.

6. The shock absorber, or hydraulic cylinder, according to one of the claims 1 to 4 wherein:
The said valve is a piloted spool type valve.

7. The shock absorber, or hydraulic cylinder, according to one of the claims 1 to 4 wherein:
The said valve is a non-piloted spool type valve.
